(19) United States
(12) Patent Application Publication
(10) Pub. No.: US 2026/0158811 A1
(43) Pub. Date: Jun. 11, 2026

(54) Bilingual Flip Book

(71) Applicant: Lara Victoria Baldwin, Winchester, VA (US)

(72) Inventor: Lara Victoria Baldwin, Winchester, VA (US)

(21) Appl. No.: 18/971,400

(22) Filed: Dec. 6, 2024

(51) Int. Cl. B42D 1/00

(52) U.S. Cl. CPC B42D 1/001

(57) ABSTRACT

When looking at the front cover of the book the back cover seems like it's upside down. It's actually the same story told over again but in a second language. The two versions/languages of the story meet in the middle of the book. It looks as if the end of the story is right faced up and another is upside down. A blank page can be placed in the center to separate the two.

### CROSS-REFERENCE TO RELATED APPLICATIONS

A story told in two languages. There are two covers and no back cover to the book. There's one full story told in the first language and then the same story told in the second language. They both read from left to right and the end of both versions meet in the middle of the book. There is a blank page in the middle of the book to separate them.

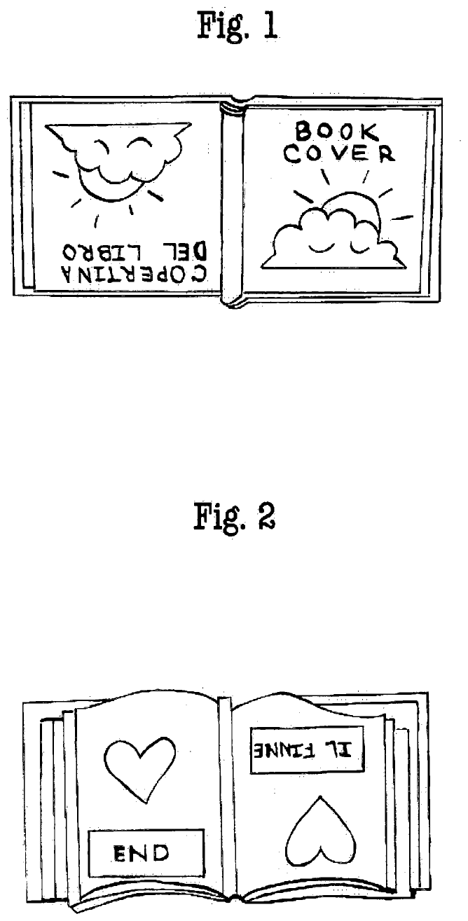

As shown in FIG. 1, both front and back of book are front cover in different languages. Each are the same story that meets in the middle but in two different languages. There is no back cover. Both versions read from left to right.

As shown in FIG. 2, the blank page in the center of book. The first half of book is in the first language and the second half of the book is in a second language.

1. A book with one story told but in two languages. Each language is separated and read from left to right meeting in the middle of the book. There are two front covers in each language and no back cover.
